(19) United States
(12) Patent Application Publication
(10) Pub. No.: US 2017/0149672 A1
(43) Pub. Date: May 25, 2017

(54) APPARATUS AND METHOD TO TRANSFER PATH INFORMATION DEPENDING ON A DEGREE OF PRIORITY OF A PATH

(71) Applicant: FUJITSU LIMITED, Kawasaki-shi (JP)

(72) Inventors: Masayuki Ogawa, Kawanishi (JP); Yoshimi Toyoda, Osaka (JP); TAMOTSU MATSUO, Osaka (JP)

(73) Assignee: FUJITSU LIMITED, Kawasaki-shi (JP)

(21) Appl. No.: 15/295,411

(22) Filed: Oct. 17, 2016

(30) Foreign Application Priority Data
Nov. 20, 2015 (JP) 2015-227782

(51) Int. Cl. H04L 12/833; H04L 12/939; H04L 12/703

(52) U.S. Cl. CPC H04L 47/2458; H04L 45/28; H04L 49/552

(57) ABSTRACT

An apparatus includes line interface cards coupled to a plurality of paths, a first processor configured to control the line interface cards, and a controller including a second processor. The second processor is configured to detect notification information from the line interface cards and determine whether the detected notification information is priority path notification information indicating information on a priority path having a high priority level among the plurality of paths, and transfer the priority path notification information to the first processor, with a higher priority than non-priority path notification information indicating information on a non-priority path other than the priority path.

### CROSS-REFERENCE TO RELATED APPLICATION

This application is based upon and claims the benefit of priority of the prior Japanese Patent Application No. 2015-227782, filed on Nov. 20, 2015, the entire contents of which are incorporated herein by reference.

### FIELD

The embodiments discussed herein are relate to apparatus and method to transfer path information depending on a degree of priority of a path.

### BACKGROUND

A transfer device has a path protection function for switching an working path to a standby path when a failure is detected. A transfer device uses, for example, 1K paths constituted by 1024 pairs of working paths and standby paths and is standardized to switch the 1024 pairs of working paths and standby paths within 50 ms. Moreover, the number of paths will increase dramatically in the future and, for example, it is expected that there will be 32K paths constituted by 1024 pairs×32.

Japanese Laid-open Patent Publication No. 06-334705 and Japanese Laid-open Patent Publication No. 07-307762, for example, discuss the above prior art.

### SUMMARY

According to an aspect of the invention, an apparatus includes line interface cards coupled to a plurality of paths, a first processor configured to control the line interface cards, and a controller including a second processor. The second processor is configured to detect notification information from the line interface cards and determine whether the detected notification information is priority path notification information indicating information on a priority path having a high priority level among the plurality of paths, and transfer the priority path notification information to the first processor, with a higher priority than non-priority path notification information indicating information on a non-priority path other than the priority path.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a transfer system, according to an embodiment;

FIG. 2 is a diagram illustrating an example of a configuration inside a unit management (UM), according to an embodiment;

FIG. 3 is a diagram illustrating an example of a table configuration of a priority buffer pointer, according to an embodiment;

FIG. 4 is a diagram illustrating an example of a table configuration of a non-priority buffer pointer, according to an embodiment;

FIG. 5 is a diagram illustrating an example of a format of an automatic protection switching (APS) signal, according to an embodiment;

FIG. 6 is a diagram illustrating an example of a format of an alarm indication signal (AIS), according to an embodiment;

FIG. 7 is a diagram illustrating an example of an operational flowchart for UM processing operations pertaining to transfer processing, according to an embodiment; and

FIG. 8 is a diagram illustrating an example of a transfer system, according to an embodiment.

### DESCRIPTION OF EMBODIMENTS

It is difficult to switch a 32K path, that is, a 1024 pair×32 working paths and standby paths within 50 ms in a transfer device with a 32K paths, for example. Conversely, while high priority paths that are desirably switched within 50 ms are present among the 32K paths, low priority paths that do not have to switch within 50 ms are also present. Specifically, due to the occurrence of processing standbys due to the transfer of notification information in paths with a low priority level, transfer delays of notification information in a priority path having a high priority level occur in transfer devices. As a result, the switching of the priority paths is delayed due to the transfer delays of the notification information in the priority paths.

An object of one aspect of the embodiments discussed herein is to provide a transfer device and an information transfer method that are able to preferentially execute the transfer of notification information in priority paths having a high priority level.

The following is a detailed explanation of embodiments of a transfer device and an information transfer method disclosed in the present application with reference to the accompanying drawings. However, the techniques disclosed herein are not limited by the present embodiments. Further, the following embodiments may be combined as appropriate within a range that does not lead to inconsistencies.

### First Embodiment

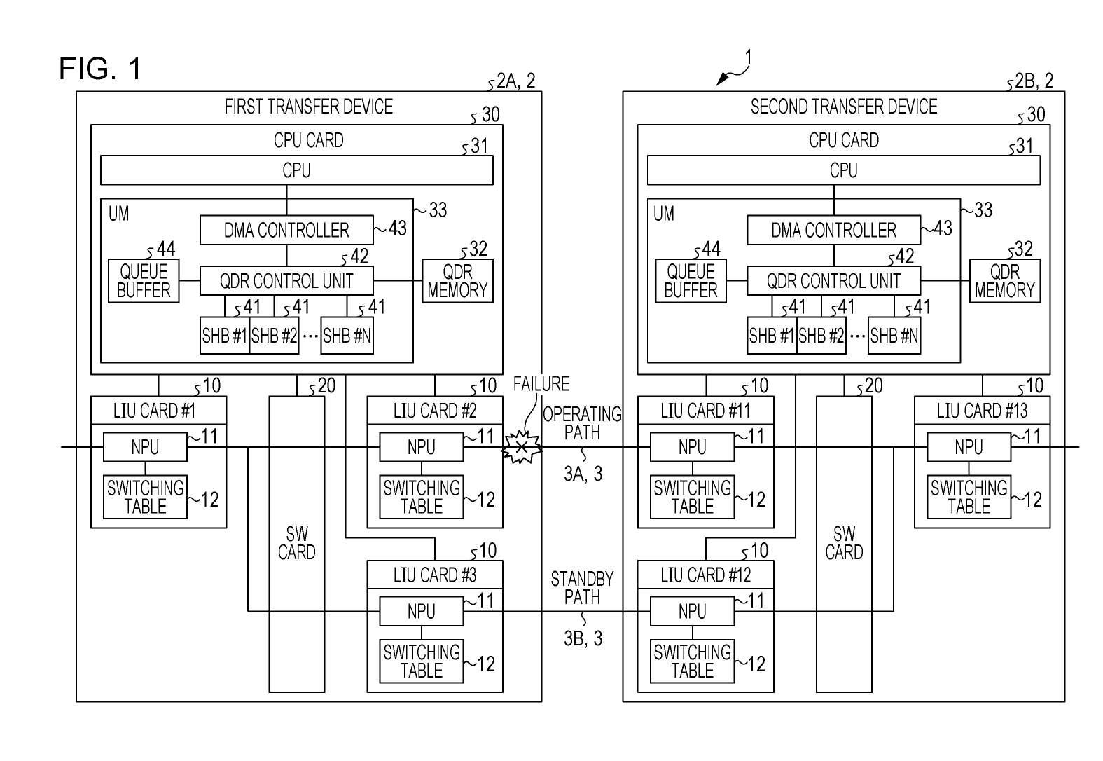

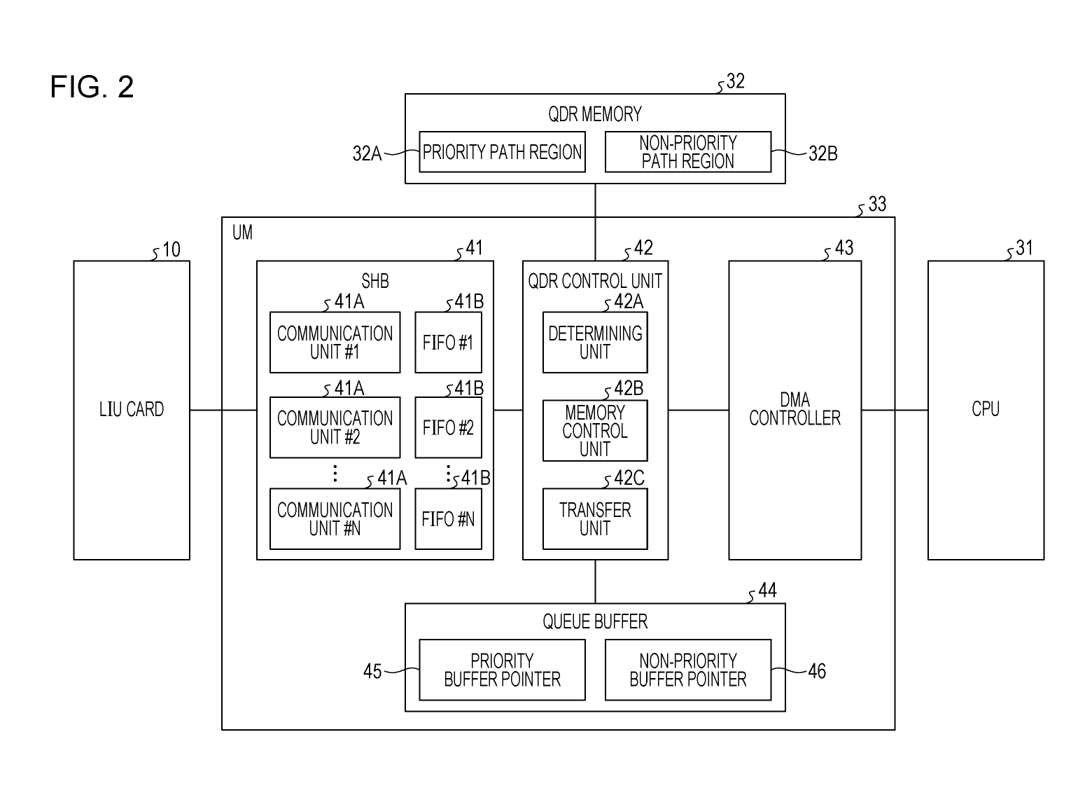

FIG. 1 is a block diagram of an example of a transfer system 1 in a first embodiment, and FIG. 2 is a block diagram of an example of a configuration inside a UM. The transfer system 1 illustrated in FIG. 1 includes a plurality of transfer devices 2, and among the plurality of transfer devices 2, a first transfer device 2A and a second transfer device 2B are coupled via a plurality of paths 3. The transfer system 1 is configured by using a path protection of ITU-T G.8031. The first transfer device 2A is coupled to the second transfer device 2B with a redundant configuration including a working path 3A and a standby path 3B. For ease of explanation, one pair of paths made up of the working path 3A and the standby path 3B is exemplified between the first transfer device 2A and the second transfer device 2B; however, the transfer system 1 may include a 1024 pair×32 32K-path configuration, for example. The transfer devices 2 are, for example, packet transfer devices such as L2SW devices. The transfer device 2 has mounted therein line interface unit (LIU) cards 10, a switch (SW) card 20, and a central processing unit (CPU) card 30. The LIU card 10 is a circuit such as a communication interface for connecting with the paths 3. The LIU cards 10 each have a network processing unit (NPU) 11 and a switching table 12. The NPU 11 controls the entire LIU card 10, and governs and monitors communication with the paths 3. The switching table 12 is a table for storing switching information of the paths 3. The NPU 11 monitors the paths 3, and when a failure in the working path 3A is detected, issues notification information such as failure information to an SHB 41 coupled to the LIU cards 10. Hereinafter, a line interface unit (LIU) card will be also abbreviated to “a line interface card”.

The SW card 20 is a switch for switching the paths 3 between the LIU cards 10. The CPU card 30 includes a CPU 31, a quad data rate (QDR) memory 32, and a unit management (UM) 33. The CPU 31 controls the entire CPU card 30. The QDR memory 32 is a region for storing various types of information such as the notification information and the like. The QDR memory 32 has a priority path region 32A for storing notification information for a priority path, and a non-priority path region 32B for storing notification information for a non-priority path. The priority path corresponds to a circuit path for a service having a high priority level that does not allow communication interruptions over a long period of time within the plurality of paths 3, such as a circuit path for a financial institution, and the non-priority path corresponds to a circuit path having a low priority level within the plurality of paths 3. The priority path and the non-priority path may be set and changed as appropriate. For example, 1K paths among the 32K paths are set as the priority paths, and the remaining 31K paths are set as the non-priority paths. The priority path region 32A is a first memory unit. The non-priority path region 32B is a second memory unit. The UM 33 includes the serial hard bus (SHB) 41, a QDR control unit 42, a direct memory access (DMA) controller 43, and a queue buffer 44.

The SHB 41 is a local bus for transferring, for example, various types of information such as the notification information between the QDR control unit 42 and the LIU cards 10. As illustrated in FIG. 4, the SHB 41 includes #1 to #N communication units 41A each coupled to a LIU card 10, and #1 to #N FIFOs 41B that temporarily store information for each communication unit 41A. The QDR control unit 42 is a controller for controlling the memory of the QDR memory 32. The DMA controller 43 couples, for example, the QDR control unit 42 and the CPU 31, and is a controller for carrying out DMA transfer of the notification information stored in the QDR memory 32. The queue buffer 44 is a region for storing management information for managing the notification information inside the QDR memory 32.

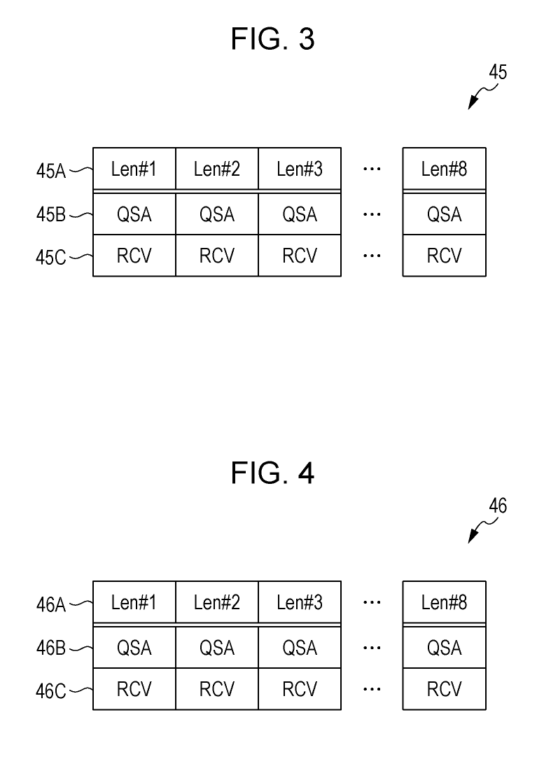

The queue buffer 44 has a priority buffer pointer 45 and a non- priority buffer pointer 46. FIG. 3 is a view for explaining an example of the priority buffer pointer 45. The priority buffer pointer 45 stores management information of a length (Len) 45A, a QSA 45B, and a RCV bit 45C, in association with each piece of notification information stored in the priority path region 32A. The priority buffer pointer 45 is set to store the management information pertaining to eight pieces of notification information for example. The Len 45A is, for example, a data amount of the notification information stored in the priority path region 32A. The QSA 45B is an address of the priority path region 32A that stores the notification information. The RCV bit 45C is an identifier identifying whether or not the notification information stored in the priority path region 32A has been transferred to the CPU 31. The RCV bit 45C being “0” indicates that the notification information has been transferred to the CPU 31, and the RCV bit 45C being “1” indicates that the notification information has not been transferred to the CPU 31. FIG. 4 is a view for explaining an example of the non-priority buffer pointer 46. The non-priority buffer pointer 46 stores management information of a Len 46A, a QSA 46B, and a RCV bit 46C, in association with each piece of notification information stored in the non-priority path region 32B. The non-priority buffer pointer 46 is set to store the management information pertaining to eight pieces of notification information, for example. The Len 46A is, for example, a data amount of the notification information stored in the non-priority path region 32B. The QSA 46B is an address of the non-priority path region 32B that stores the notification information. The RCV bit 46C is an identifier identifying whether or not the notification information stored in the non-priority path region 32B has been transferred to the CPU 31.

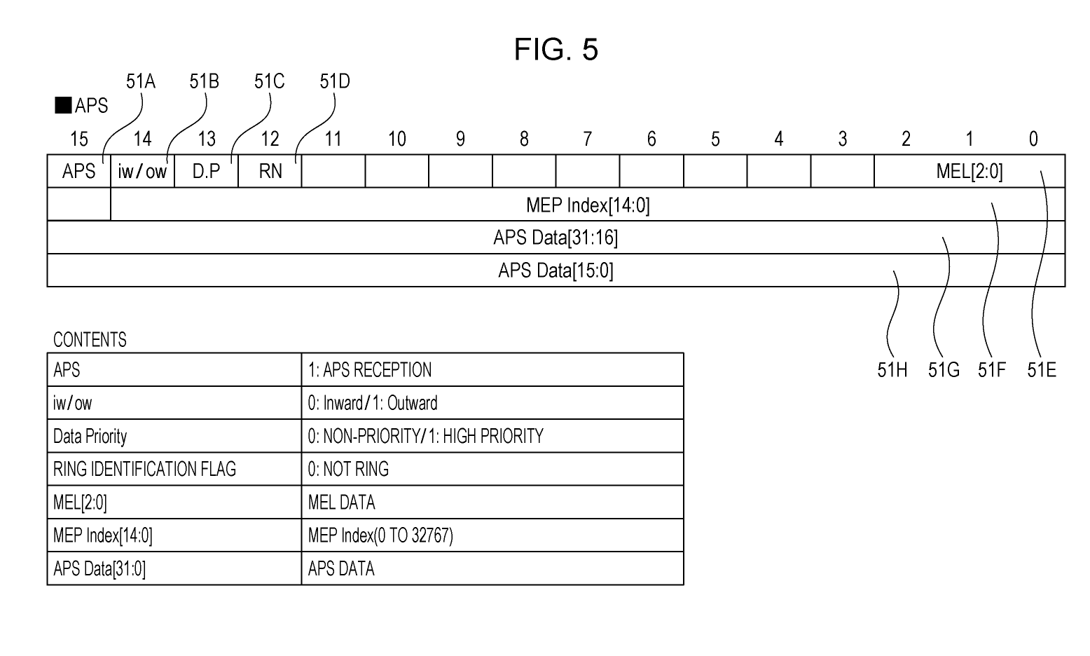

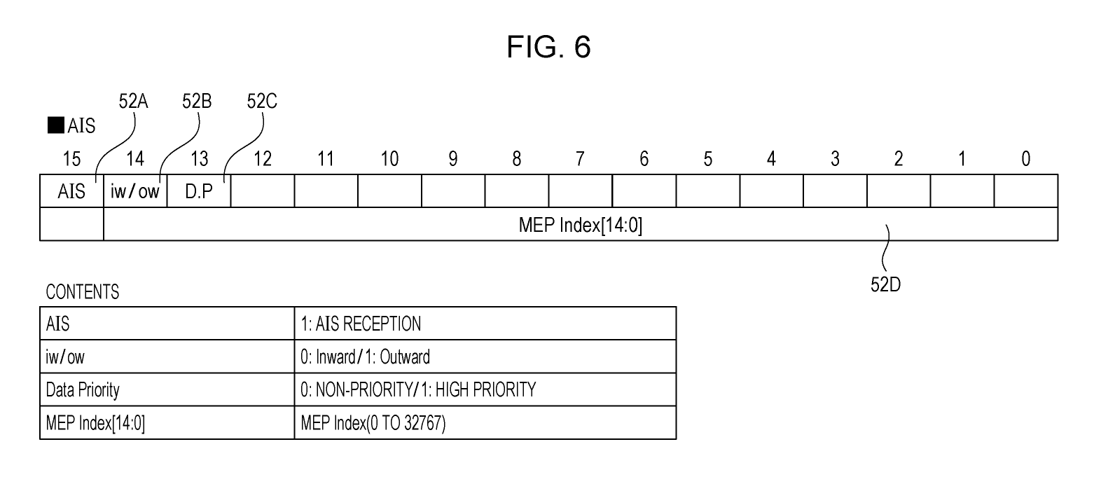

The QDR control unit 42 illustrated in FIG. 2 includes a determining unit 42A, a memory control unit 42B, and a transfer unit 42C. The QDR control unit 42 may be configured to include a processor that performs the functions of the determining unit 42A, the memory control unit 42B, and the transfer unit 42C. The determining unit 42A determines whether each piece of notification information received via the SHB 41 is information on a priority path or information on a non-priority path. The notification information is, for example, a failure signal, a link down signal, an automatic protection switching (APS) signal, an alarm indication signal (AIS), a remote defect indication (RDI) signal, and a loss of continuity check (LOC) signal. FIG. 5 is a view for explaining an example of a signal format of an APS signal, and FIG. 6 is a view for explaining an example of a signal format of an AIS signal. An APS signal 51 illustrated in FIG. 5 includes an identification label 51A, an iw/ow 51B, a D.P (data priority) 51C, a RN 51D, a maintenance entity level (MEL) 51E, a MEP index 51F, and APS data 51G. The identification label 51A is information for identifying an APS signal. The iw/ow 51B is an identifier identifying inward or outward. The D.P 51C is an identifier identifying information on the priority path or the non-priority path. The D.P 51C being “0” indicates a non-priority path APS signal, and the D.P 51C being “1” indicates a priority path APS signal. The RN 51D is a ring identifier and indicates whether the system is a ring system. The RN 51D being “1” indicates a ring system and the RN 51D being “0” indicates that the system is not a ring system. The APS data 51G is data such as Request/State, Prot.Type, Request Signal, Bridged Signal, and Reserved data.

The AIS signal 52 illustrated in FIG. 6 includes an identification label 52A, an iw/ow 52B, a D.P 52C, and a MEP index 52D. The identification label 52A is information identifying the AIS signal 52. The iw/ow 52B is an identifier identifying inward or outward. The D.P 52C is an identifier identifying information on the priority path or the non-priority path. The D.P 52C being “0” indicates information on a non-priority path, and the D.P 52C being “1” indicates information on a priority path.

The determining unit 42A determines whether or not the notification information is information on a priority path or information on a non-priority path, based on the priority level (D.P) within the notification information. The memory control unit 42B stores the notification information in the priority path region 32A inside the QDR memory 32 when the notification information pertains to a priority path. Further, the memory control unit 42B stores the notification information in the non-priority path region 32B inside the QDR memory 32 when the notification information pertains to a non-priority path.

The transfer unit 42C refers to the RCV bit 45C in the priority buffer pointer 45, and preferentially transfers, to the CPU 31, the notification information of the priority path stored in the priority path region 32A when the RCV bit 45C is “1”. As a result, the CPU 31 executes priority path processing based on the priority path notification information stored in the priority path region 32A.

Further, the transfer unit 42C refers to the RCV bit 45C in the priority buffer pointer 45, and when the RCV bit 45C is “0”, refers to the RCV bit 46C in the non-priority buffer pointer 46. When all the RCV bits 45C in the priority buffer pointer 45 are “0” and there is a RCV bit 46C whose value is “1” in the non-priority buffer pointer 46, the transfer unit 42C transfers, to the CPU 31, the non-priority path notification information stored in the non-priority path region 32B. As a result, the CPU 31 executes non-priority path processing based on the transferred non-priority path notification information.

The following is an explanation about operations of the transfer system 1 according to the embodiment. First, operations pertaining to path switch processing in the transfer system 1 will be explained. The #2 LIU card 10 in the first transfer device 2A illustrated in FIG. 1 outputs a failure signal via the coupled SHB 41 to the QDR control unit 42 when the #2 LIU card 10 detects a failure of the working path 3A between the #2 LIU card 10 and the #11 LIU card 10 in the second transfer device 2B.

When the failure signal is detected, the memory control unit 42B in the QDR control unit 42 of the first transfer device 2A stores the failure signal in the QDR memory 32 according to the belowmentioned transfer processing. Furthermore, the transfer unit 42C in the QDR control unit 42 transfers the failure signal stored in the QDR memory 32 to the DMA controller 43 based on the transfer processing. The DMA controller 43 then transfers the failure signal to the CPU 31.

The CPU 31 in the first transfer device 2A issues a switching instruction for switching from the working path 3A to the standby path 3B, to the #1 LIU card 10 via the DMA controller 43, the QDR control unit 42, and the SHB 41, based on the failure signal. As a result, the NPU 11 in the #1 LIU card 10 updates the contents of the switching table 12 so as to switch the operation from the working path 3A to the standby path 3B in response to the switching instruction.

Furthermore, the CPU 31 issues a transmission instruction for an APS (signal fail (SF)) to the #2 and #3 LIU cards 10 via the DMA controller 43, the QDR control unit 42, and the SHB 41, based on the failure signal. The #2 and #3 LIU cards 10 transmit the APS (SF) to the second transfer device 2B via the paths 3 when the transmission instruction of the APS (SF) is detected.

The NPUs 11 in the #11 and #12 LIU cards 10 in the second transfer device 2B issue the APS (SF) via the SHB 41 to the QDR control unit 42 when the APS (SF) from the first transfer device 2A is detected. The memory control unit 42B in the QDR control unit 42 of the second transfer device 2B stores the APS (SF) in the QDR memory 32 based on the belowmentioned transfer processing. That is, the memory control unit 42B stores the APS (SF) of the priority path in the priority path region 32A and stores the APS (SF) of the non-priority path in the non-priority path region 32B.

Furthermore, the transfer unit 42C in the QDR control unit 42 of the second transfer device 2B transfers the APS (SF) stored in the QDR memory 32 to the DMA controller 43 based on the transfer processing. The DMA controller 43 in the second transfer device 2B then transfers the APS (SF) to the CPU 31.

The CPU 31 recognizes the failure of the working path between the CPU 31 and the first transfer device 2A, based on the APS (SF). The CPU 31 issues a switching instruction for switching the path from the working path 3A to the standby path 3B, to the #13 LIU card 10 via the DMA controller 43, the QDR control unit 42, and the SHB 41. As a result, the NPU 11 in the #13 LIU card 10 updates the contents of the switching table 12 so as to switch the operation from the working path 3A to the standby path 3B in response to the switching instruction.

Furthermore, the CPU 31 issues a transmission instruction for an APS (no request (NR)) to the #11 and #12 LIU cards 10 via the DMA controller 43, the QDR control unit 42, and the SHB 41, based on the APS (SF). The #11 and #12 LIU cards 10 issue the APS (NR) to the first transfer device 2A in response to the transmission instruction of the APS (NR).

The #2 and #3 LIU cards 10 in the first transfer device 2A transfer a switching completion to the CPU 31 when the APS (NR) from the second transfer device 2B is detected. As a result, the first transfer device 2A recognizes the completion of switching from the working path 3A to the standby path 3B.

The UM 33 in the first transfer device 2A preferentially transfers the priority path notification information to the CPU 31 when the notification information from the LIU card 10 is transferred to the CPU 31. Moreover, when the UM 33 of the second transfer device 2B transfers the notification information (APS (SF)) from the LIU card 10 to the CPU 31, the priority path notification information is transferred preferentially to the CPU 31.

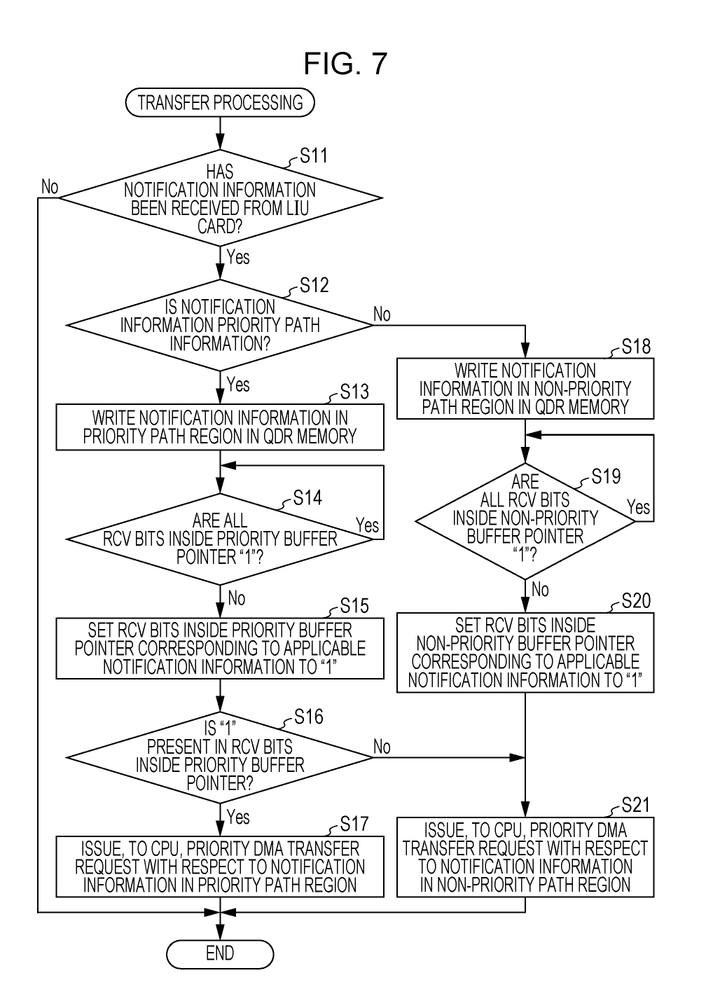

Next, the transfer processing will be explained. FIG. 7 is an operational flowchart of an example of the UM 33 processing operations pertaining to transfer processing. The transfer processing illustrated in FIG. 7 involves determining whether the notification information from the LIU card 10 is priority path information (information on a priority path) or non-priority path information (information on a non-priority path), and when the notification information is the priority path information, the priority path information is transferred preferentially to the CPU 31.

The UM 33 determines whether or not notification information has been received from the LIU card 10 via the SHB 41 in FIG. 7 (step S11). When the notification information is received (step S11: Yes), the determining unit 42A in the UM 33 determines whether or not the notification information is the priority path information (step S12). The determining unit 42A determines whether the notification information is the priority path information or the non-priority path information, based on the D.P (priority level) in the header within the notification information.

When the notification information is the priority path information (step S12: Yes), the memory control unit 42B in the UM 33 writes the priority path notification information in the priority path region 32A in the QDR memory 32 (step S13). When the memory control unit 42B writes the priority path notification information in the priority path region 32A, the memory control unit 42B updates the contents of the priority buffer pointer 45. After writing the notification information in the priority path region 32A, the memory control unit 42B determines whether or not all the RCV bits 45C inside the priority buffer pointer 45 are “1” (step S14).

When there exists at least one RCV bit 45C whose value is “1” in the priority buffer pointer 45 (step S14: No), the memory control unit 42B sets the RCV bit 45C in the priority buffer pointer 45 corresponding to the notification information written in the priority path region 32A at “1” (step S15). Furthermore, the memory control unit 42B refers to the RCV bits 45C in the priority buffer pointer 45 and determines whether or not “1” is present among the RCV bits 45C (step S16).

When “1” is present among the RCV bits 45C in the priority buffer pointer 45 (step S16: Yes), the transfer unit 42C issues, to the CPU 31, a DMA transfer request with respect to the notification information in the priority path region 32A (step S17), and then the processing operations depicted in FIG. 7 are finished. In this way, the transfer unit 42C is able to transfer the priority path notification information to the CPU 31 with a higher priority than the non-priority path notification information. As a result, the CPU 31 executes the priority path processing based on the transferred priority path notification information.

Moreover, when the notification information is not priority path information (step S12: No), that is, when the notification information is non-priority path information, the memory control unit 42B writes the notification information in the non-priority path region 32B in the QDR memory 32 (step S18). When the memory control unit 42B writes the non-priority path notification information in the non-priority path region 32B, the memory control unit 42B updates the contents of the non-priority buffer pointer 46. Furthermore, the memory control unit 42B determines whether or not all of the RCV bits 46C in the non-priority buffer pointer 46 are “1” (step S19). When there exists at least one RCV bit 46C whose value is “1” in the non-priority buffer pointer 46 (step S19: No), the memory control unit 42B sets the RCV bit 46C in the non-priority buffer pointer 46 of the notification information written in the non-priority path region 32B in step S18 at “1” (step S20). Furthermore, the transfer unit 42C issues, to the CPU 31, the DMA transfer request with respect to the notification information in the non-priority path region 32B (step S21), and the processing operations depicted in FIG. 7 are finished. In this way, the transfer unit 42C is able to transfer the non-priority path notification information to the CPU 31. As a result, the CPU 31 executes the non-priority path processing based on the transferred non-priority path notification information.

When the memory control unit 42B does not receive the notification information from the LIU card 10 (step S11: No), the processing operations depicted in FIG. 7 are finished. When all of the RCV bits 45C in the priority buffer pointer 45 are “1” (step S14: Yes), the memory control unit 42B moves to step S14 until any one of the RCV bits 45C become “0”. The memory control unit 42B stores the received notification information at an address in the priority path region 32A corresponding to the RCV bits 45C in the priority buffer pointer 45 which are “0”.

When “1” is not present among the RCV bits 45C in the priority buffer pointer 45 (step S16: No), the transfer unit 42C moves to step S21 so as to issue, to the CPU 31, the DMA transfer request corresponding to the notification information in the non-priority path region 32B.

Moreover, when all of the RCV bits 46C in the non-priority buffer pointer 46 are “1” (step S19: Yes), the memory control unit 42B moves to step S19 until any one of the RCV bits 46C become “0”. The memory control unit 42B stores the received notification information at an address in the non-priority path region 32B corresponding to the RCV bits 46C in the non-priority buffer pointer 45 which are “0”.

The QDR control unit 42 in the UM 33 which executes the transfer processing depicted in FIG. 7 receives the notification information from the LIU card 10 via the SHB 41 and evaluates the received notification information. When the notification information is the priority path information, the QDR control unit 42 stores the priority path notification information in the priority path region 32A and sets the corresponding RCV bit 45C in the priority buffer pointer 45 at “1”. The transfer unit 42C then preferentially transfers, to the CPU 31, the notification information of the priority path stored in the priority path region 32A when the corresponding RCV bit 45C in the priority buffer pointer 45 is “1”. The CPU 31 then preferentially executes the priority path processing based on the preferentially transferred priority path notification information. As a result, a delay in the processing of the priority path due to the processing of the non-priority path may be avoided.

When the received notification information is the non-priority path information, the QDR control unit 42 stores the non-priority path notification information in the non-priority path region 32B and sets the RCV bit 46C in the non-priority buffer pointer 46 at “1”. When none of the RCV bits 45C in the priority buffer pointer 45 are “1” and the corresponding RCV bit 46C in the non-priority buffer pointer 46 is “1”, the QDR control unit 42 transfers the non-priority path notification information indicated by “1” to the CPU 31. The CPU 31 then executes the non-priority path switching processing based on the transferred non-priority path notification information. As a result, the switching processing of the non-priority path can be executed.

The transfer device 2 in the first embodiment detects the notification information from the LIU card 10 and determines whether the detected notification information is the priority path information. The transfer device 2 preferentially transfers the notification information to the CPU 31 when the notification information is the priority path information. As a result, a delay in transferring the priority path notification information due to the transfer of the non-priority path notification information may be avoided.

The transfer device 2 includes the priority path region 32A for storing the notification information for the priority path, and the non-priority path region 32B for storing the notification information for the non-priority path. When the detected notification information is the priority path information, the transfer device 2 stores the priority path notification information in the priority path region 32A, and when the notification information is the non-priority path information, the transfer device 2 stores the non-priority path notification information in the non-priority path region 32B. As a result, the priority path notification information and the non-priority path notification information may be stored in different regions.

When there exists notification information not yet transferred to the CPU 31 among the notification information stored in the priority path region 32A, the transfer device 2 transfers the un-transferred notification information to the CPU 31 with a higher priority than the non-priority path notification information. As a result, even when non-priority paths have increased in number, the CPU 31 is able to preferentially obtain the priority path notification information.

The transfer device 2 executes the priority path switching processing based on the preferentially transferred priority path notification information. As a result, a delay in the transfer of the priority path notification information due to the transfer of the non-priority path notification information is avoided, whereby a delay in the switching processing based on the priority path notification information may be avoided.

While a system having a path protection configuration is exemplified as the transfer system 1 in the first embodiment, the system may also be applicable to a ring protection configuration, and an embodiment of such a case is explained below as the second embodiment.

### Embodiment 2

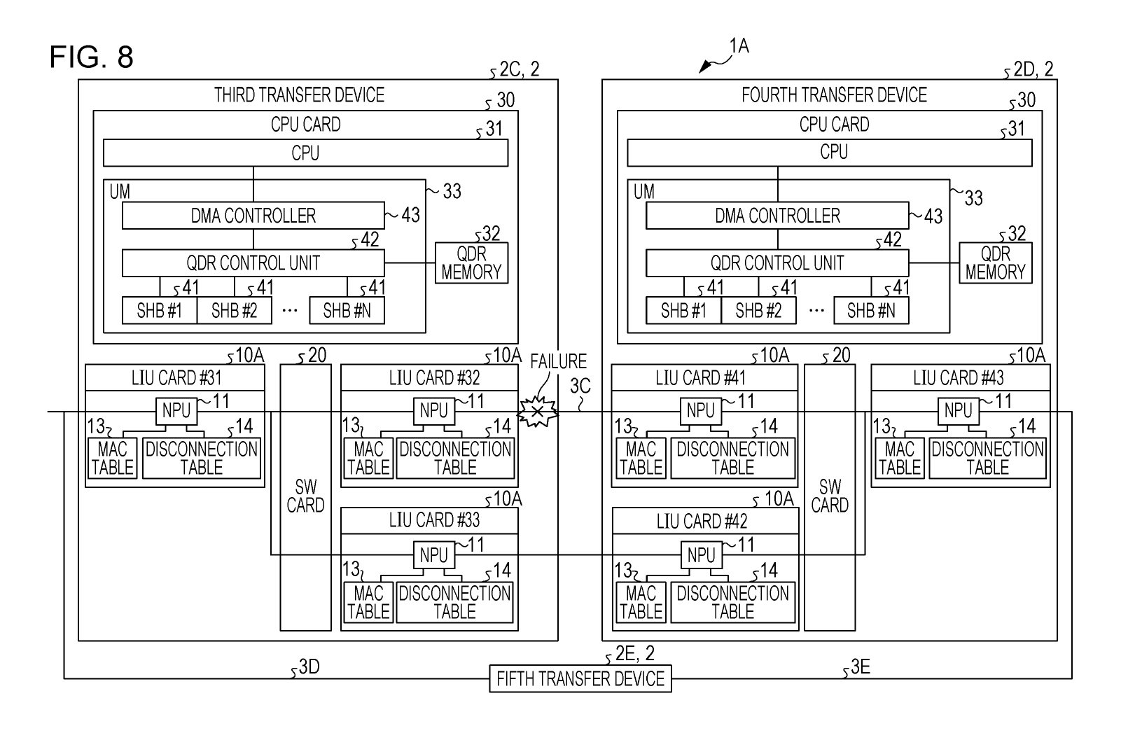

FIG. 8 is a block diagram of an example of a transfer system 1A according to a second embodiment. The same reference numerals are attached to configurations that are the same as those of the transfer system 1 in the first embodiment and explanations regarding duplicate configurations and operations will be omitted. The transfer system 1A illustrated in FIG. 8 includes, for example, a third transfer device 2C (2), a fourth transfer device 2D (2), and a fifth transfer device 2E (2) which are coupled with an ITU-T G.8032 ring protection configuration. For the ease of explanation, it is assumed that a path 3C between the third transfer device 2C and the fourth transfer device 2D is working, a path 3D between the third transfer device 2C and the fifth transfer device 2E is disconnected, and a path 3E between the fourth transfer device 2D and the fifth transfer device 2E is disconnected.

The third transfer device 2C has mounted thereon #31 to #33 LIU cards 10A. The fourth transfer device 2D has mounted thereon #41 to #43 LIU cards 10A. The LIU cards 10A each include the NPU 11, a MAC table 13, and a disconnection table 14. MAC addresses of the transfer device 2 that is the path switching target are stored in the MAC table 13. MAC addresses of the transfer device 2 that is the disconnection target are stored in the disconnection table 14. The fifth transfer device 2E also includes LIU cards 10A which are not illustrated.

For example, the MAC address of the fifth transfer device 2E which is disconnected is stored in the disconnection table 14 in the #31 LIU card 10A in the third transfer device 2C. Further, the MAC address of the fifth transfer device 2E which is disconnected is stored in the disconnection table 14 in the #41 LIU card 10A in the fourth transfer device 2D.

When a failure occurs in the working path 3C between the third transfer device 2C and the fourth transfer device 2D, the third transfer device 2C disconnects the working path 3C between the third transfer device 2C and the fourth transfer device 2D and switches to the path 3D between the third transfer device 2C and the fifth transfer device 2E. The fourth transfer device 2D disconnects the working path 3C between the fourth transfer device 2D and the third transfer device 2C and switches to the path 3E between the fourth transfer device 2D and the fifth transfer device 2E.

The following is an explanation about operations of the transfer system 1A according to the second embodiment. Operations related to path switching processing in the transfer system 1A will be explained. The #32 LIU card 10A in the third transfer device 2C illustrated in FIG. 8 outputs a failure signal via the coupled SHB 41 to the QDR control unit 42 when a failure is detected in the working path 3C between the #32 LIU card 10A and the #41 LIU card 10A in the fourth transfer device 2D.

When the failure signal is detected, the memory control unit 42B in the QDR control unit 42 of the third transfer device 2C stores the failure signal in the QDR memory 32 based on the transfer processing. Furthermore, the transfer unit 42C in the QDR control unit 42 transfers the failure signal stored in the QDR memory 32 to the DMA controller 43 according to the transfer processing. The DMA controller 43 then transfers the failure signal to the CPU 31. That is, when the failure signal pertains to a priority path, the transfer unit 42C preferentially transfers the failure signal to the CPU 31. As a result, the CPU 31 preferentially executes the processing of the priority path based on the failure signal of the priority path. When none of the RCV bits 45C in the priority buffer pointer 45 are “1” and there is a RCV bit 46C whose value is “1” in the non-priority buffer pointer 46, the transfer unit 42C transfers the failure signal of the non-priority path to the CPU 31. As a result, the CPU 31 executes the processing of the non-priority path based on the failure signal of the non-priority path.

The CPU 31 in the third transfer device 2C issues a R-APS (SF) transmission instruction to the #31 LIU card 10 via the DMA controller 43, the QDR control unit 42, and the SHB 41, based on the failure signal. Moreover, the CPU 31 issues a flush instruction of the MAC table 13 to the #33 LIU card 10 via the DMA controller 43, the QDR control unit 42, and the SHB 41, based on the failure signal. Furthermore, the CPU 31 issues a switching instruction to the #31 and #32 LIU cards 10A via the QDR control unit 42, based on the failure signal, so as to disconnect the failed working path 3C to the fourth transfer device 2D and to open the path 3D to the fifth transfer device 2E.

The NPU 11 in the #33 LIU card 10A erases the contents of the MAC table 13 when the flush instruction is detected. Furthermore, when the switching instruction is detected, the NPU 11 in the #32 LIU card 10A stores, in the disconnection table 14, the address of the fourth transfer device 2D to be disconnected, so as to disconnect the failed working path 3C to the fourth transfer device 2D. When the switching instruction is detected, the NPU 11 in the #31 LIU card 10A erases the address of the fifth transfer device 2E to be opened, from the disconnection table 14, so as to open the disconnection of the fifth transfer device 2E to be disconnected.

When the transmission instruction of the R-APS (SF) is detected, the NPU 11 in the #31 LIU card 10A transmits the R-APS (SF) to the fifth transfer device 2E. Furthermore, the fifth transfer device 2E transmits the received R-APS (SF) to the fourth transfer device 2D. When the R-APS (SF) from the fifth transfer device 2E is detected, the NPU 11 in the #43 LIU card 10A in the fourth transfer device 2D outputs the R-APS (SF) to the SHB 41 in the coupled UM 33.

When the R-APS (SF) is detected, the memory control unit 42B in the QDR control unit 42 of the fourth transfer device 2D stores the R-APS (SF) in the QDR memory 32, based on the transfer processing. When the R-APS (SF) pertains to a priority path, the memory control unit 42B in the QDR control unit 42 stores the R-APS (SF) in the priority path region 32A. Moreover, when the R-APS (SF) pertains to a non-priority path, the memory control unit 42B in the QDR control unit 42 stores the R-APS (SF) in the non-priority path region 32B. Furthermore, the transfer unit 42C in the QDR control unit 42 transfers the R-APS (SF) stored in the QDR memory 32 to the DMA controller 43, based on the transfer processing. The DMA controller 43 then transfers the R-APS (SF) to the CPU 31. That is, the transfer unit 42C preferentially transfers the R-APS (SF) to the CPU 31 when the R-APS (SF) pertains to a priority path. As a result, the CPU 31 preferentially executes the processing of the priority path based on the R-APS (SF) of the priority path. When none of the RCV bits 45C in the priority buffer pointer 45 are “1” and a RCV bit 46C whose value is “1” is included among the RCV bits 46C in the non-priority buffer pointer 46, the transfer unit 42C transfers the R-APS (SF) of the non-priority path to the CPU 31. As a result, the CPU 31 executes the non-priority path processing based on the non-priority path R-APS (SF)

The CPU 31 in the fourth transfer device 2D issues a R-APS (NR) transmission instruction to the #43 LIU card 10A via the DMA controller 43, the QDR control unit 42, and the SHB 41, based on the R-APS (SF). Moreover, the CPU 31 issues a flush instruction of the MAC table 13 to the #42 LIU card 10A via the DMA controller 43, the QDR control unit 42, and the SHB 41, based on the R-APS (SF). The CPU 31 then issues, based on the R-APS (SF), a switching instruction to the #41 and #43 LIU cards 10A via the QDR control unit 42 and the SHB 41, so as to disconnect the path 3C to the third transfer device 2C and open the path 3E to the fifth transfer device 2E.

The NPU 11 in the #42 LIU card 10A erases the contents of the MAC table 13 when the flush instruction is detected. Furthermore, when the switching instruction is detected, the NPU 11 in the #41 LIU card 10A stores, in the disconnection table 14, the address of the fourth transfer device 2D to be disconnected, so as to disconnect the third transfer device 2C of the failed working path 3C. When the switching instruction is detected, the NPU 11 in the #43 LIU card 10A erases the address of the fifth transfer device 2E to be opened, from the disconnection table 14, so as to release the disconnection of the fifth transfer device 2E that was disconnected.

When the transmission instruction of the R-APS (NR) is detected, the NPU 11 in the #43 LIU card 10A transmits the R-APS (NR) to the fifth transfer device 2E. Furthermore, the fifth transfer device 2E transmits the received R-APS (NR) to the third transfer device 2C. The #31 LIU card 10A in the third transfer device 2C transfers a switching completion to the CPU 31 when the R-APS (NR) from the fifth transfer device 2E is detected. As a result, the third transfer device 2C recognizes the completion of the switching processing of the path 3D between the third transfer device 2c and the fourth transfer device 2D via the fifth transfer device 2E.

The UM 33 in the third transfer device 2C preferentially transfers the priority path notification information to the CPU 31 when the notification information from the LIU card 10A is transferred to the CPU 31. Moreover, when the UM 33 of the fourth transfer device 2D transfers the notification information (APS (SF)) from the LIU card 10A to the CPU 31, the priority path notification information is transferred preferentially to the CPU 31. As a result, the QDR control units 42 in the transfer devices 2 are able to preferentially execute the priority path switching processing because the priority path notification information is preferentially transferred to the CPU 31.

When the notification information is detected and when the notification information is the priority path information, the transfer device 2 in the second embodiment preferentially transfers the priority path notification information to the CPU 31 even in the case of a ring protection configuration. The CPU 31 then preferentially executes the priority path switching processing based on the preferentially transferred priority path notification information. As a result, the switching processing of the priority path is preferentially executed, whereby a delay in the switching processing of the priority path, caused by the switching processing of the non-priority path as in the prior art, may be avoided.

The transfer device 2 transfers the non-priority path notification information to the CPU 31 when the notification information is the non-priority path information and there is no priority path notification information. As a result, the switching processing of the non-priority path may be executed.

While the priority levels of the paths are classified into two levels made up of the priority path and the non-priority path in the above embodiments, the priority levels are not limited to two levels and may be classified into three or more levels.

While three transfer devices of the third transfer device 2C, the fourth transfer device 2D, and the fifth transfer device 2E, for example, are included in the ring protection configuration in the second embodiment, the number of the transfer devices is not limited to three and may be changed as appropriate.

While the QDR control unit 42 in the transfer device 2 obtains the notification information from the LIU card 10 (10A) via the SHB 41, a method of obtaining the notification information is not limited to this, and the QDR control unit 42 may receive the transfer directly from the LIU card 10 (10A) and may be changed as appropriate.

While the transfer device 2 stores the priority path and the non-priority path notification information in the QDR memory 32, the location for storing is not limited to the QDR memory 32 and may be changed as appropriate.

While the QDR control unit 42 transfers the notification information stored in the QDR memory 32 to the CPU 31 via the DMA controller 43, the transferring is not limited to the DMA transferring and the notification information may be transferred directly to the CPU 31 without passing through the DMA controller 43, and may be changed as appropriate.

While the transfer device 2 is exemplified as a packet transfer device such as a L2SW, packets to be transferred is not limited to packets of electrical signals and may also be applicable to a transfer device for optical packets.

The QDR memory 32 is housed in the transfer device 2 but may also be a memory outside of the transfer device 2.

While the priority buffer pointer 45 and the non-priority buffer pointer 46 in the transfer device 2 are each able to store eight pieces of information, the amount of information to be stored is not limited to eight pieces and may be changed as appropriate.

The constituent elements of the illustrated parts do not have to be configured physically as illustrated. In other words, the embodiments are not limited to the particular forms of distribution and integration of each part and all or some of the parts may be configured to be functionally or physically distributed or integrated in arbitrary units according to the type of load or usage conditions and the like.

Further, the various processing functions carried out by the devices may be executed entirely or in arbitrary portions on a central processing unit (CPU), a digital signal processor (DSP), or a field programmable gate array (FPGA), and the like. Moreover, various processing functions may also be carried out, entirely or in arbitrary portions, on a program that is analyzed and executed by the CPU, or on hardware based on wired logic.

The regions for storing the various types of information may be configured, for example, by a read-only memory (ROM), or a random access memory (RAM) such as a synchronous dynamic random access memory (SDRAM), a magneto-resistive random access memory (MRAM), or a non-volatile random access memory (NVRAM).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus comprising:
line interface cards coupled to a plurality of paths;
a first processor configured to control the line interface cards; and
a controller including a second processor configured to:
detect notification information from the line interface cards and determine whether the detected notification information is priority path notification information indicating information on a priority path having a high priority level among the plurality of paths, and
transfer the priority path notification information to the first processor, with a higher priority than non-priority path notification information indicating information on a non-priority path other than the priority path.

2. The apparatus of claim 1, wherein
the controller further includes:
a first memory configured to store the priority path notification information, and
a second memory configured to store the non-priority path notification information; and
the second processor stores the priority path notification information in the first memory, and stores the non-priority path notification information in the second memory.

3. The apparatus of claim 2, wherein
when there is a piece of notification information that has not been transferred by the second processor among pieces of notification information stored in the first memory, the second processor transfers, with a higher priority than the non-priority path notification information, the piece of notification information to the first processor.

4. The apparatus of claim 1, wherein
the first processor executes processing to switch the priority path, based on the priority path notification information that has been transferred to the first processor.

5. A method performed by a transfer device that includes line interface cards coupled to a plurality of paths, a first processor to control the line interface cards, and a second processor, the method comprising:
detecting, by the second processor, notification information from the line interface cards and determine whether the detected notification information is priority path notification information indicating information on a priority path having a high priority level among the plurality of paths, and
transferring, by the second processor, the priority path notification information to the first processor, with a higher priority than non-priority path notification information indicating information on a non-priority path other than the priority path.

6. The method of claim 5, further comprising:
executing, by the first processor, processing to switch the priority path based on the priority path notification information that has been transferred to the first processor.
